(19) United States
(12) Patent Application Publication
(10) Pub. No.: US 2025/0163714 A1
(43) Pub. Date: May 22, 2025

(54) INTERACTING WITH A SUBMERGED ROBOT

(71) Applicant: Maytronics Ltd., Kibutz Yizrael (IL)

(72) Inventors: Gilad Goldenberg, Kfar saba (IL); Netanel Spector, Kibbutz Regavim (IL); AVITAL WEISS FRIG, Kibutz Yizrael (IL); Ron Guy, Kibbutz Kfar-Ruppin (IL)

(73) Assignee: Maytronics Ltd., Kibutz Yizrael (IL)

(21) Appl. No.: 18/840,470

(22) PCT Filed: Apr. 20, 2023
(86) PCT No.: PCT/IB2023/054023

§ 371 Date: Aug. 21, 2024

Related U.S. Application Data
(60) Provisional application No. 63/364,112, filed on May 4, 2022.

(30) Foreign Application Priority Data
Feb. 23, 2022 (IL) 290850

(51) Int. Cl. E04H 4/16; G08C 23/02

(52) U.S. Cl. CPC E04H 4/1654; G08C 23/02

(57) ABSTRACT

A method for interacting with a submerged robot, the method may include (i) receiving by a receiver of a submerged robot, unique signals aimed to the submerged robot; wherein the unique signals are sound signals having frequencies that differ from (a) frequencies of sounds generated by the submerged robot, and (b) frequencies of sounds generated by an environment of the pool; and (ii) responding, by the submerged robot, to the unique signals.

### CROSS REFERENCE

This application claims priority from U.S. provisional patent 63/364,112 and from Israeli patent application 290850—both are incorporated in their entirety.

### BACKGROUND

It is well known that pool related platforms such as pool cleaning robots are usually being immersed into a swimming pool and their operation initiated. After that, the movement and scanning of the pool cleaning robots are governed by various navigation options.

Commands can be easily conveyed to a submerged robot via a power and communication cable connected to the submerged robot.

Users may prefer using cordless pool related platforms—in order to prevent physical interactions with such cable.

There is a growing need to interact with a submerged robot that is cordless.

### SUMMARY

There may be provided a partially submerged system, a method and a non-transitory computer readable medium for interacting with a submerged robot.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a grogger;

FIG. 3 illustrates an example of a method;

FIGS. 4-5 illustrate examples of partially submerged systems and its environment; and

FIG. 6 illustrates an example of a partially submerged system.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF THE PREFERRED EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the Summary of the invention of the specification.

The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

The term “and/or” is additionally or alternatively.

The terms “control unit”, “remote control device”, “control device” and “mobile computer” are used in an interchangeable manner.

Any reference in the specification to a pool cleaning robot should be applied mutatis mutandis to a method that can be executed by the pool cleaning robot and to a computer readable medium that stores instructions to be executed by the pool cleaning robot.

Any reference in the specification to a mobile computer should be applied mutatis mutandis to a method that can be executed by the mobile computer and to a computer readable medium that stores instructions to be executed by the mobile computer.

Any reference in the specification to method should be applied mutatis mutandis to a pool cleaning robot and/or to a mobile computer that execute the method and/or to a computer readable medium that stores instructions that once executed result in an execution of the method.

Any reference in the specification to a non-transitory computer readable medium should be applied mutatis mutandis to a pool cleaning robot and/or a mobile computer capable of executing the instructions stored in the non-transitory computer readable medium and should be applied mutatis mutandis to method that may be executed by a pool cleaning robot and/or a mobile computer that reads the instructions stored in the non-transitory computer readable medium.

Because the illustrated embodiments of the present invention may for the most part, be implemented using electronic components, touch screens and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

There may be provided a method for interacting with a pool related platforms such as submerged robot, buoy, skimmer, using unique signals that the pool related platform can receive and interpret as aimed to the pool related platforms. The unique signals may be sound signals, for example ultrasonic signals, for example—audio signals (range of 20 to 20,000 Hz) or may be of frequency that exceeds 20 Khz. The unique signals may be sound signals of high frequency. For example—the unique frequencies may be of a frequency within the 11 Khz-12 Kha range. When the pool related platform is submerged than the unique signals are designed to properly propagate through fluid of a depth of up till a few meters.

For simplicity of explanation there may be provided examples in which a pool related platform is a submerged robot—but any reference to a submerged robot may be applied mutatis mutandis to any other pool related platform—such as a buoy a skimmer, and the like

The unique signals may convey content. The content may be a command, a request, information, and the like. The content may be explicit or implicit. Implicit means that the content can be learnt from the frequency and/or intensity or any other property of the unique signals themselves.

The pool related platforms may respond to the content by at least one of executing a command, responding to a request (for example deciding to execute the request or to reject the request), and/or process the information. The executing and/or responding and/or processing may amount to one or more changes of any parameter of operation of the submerged robot. For example, a submerged robot, in response to the content may surface, perform any movement, stop any movement, perform any cleaning operation, start or stop any cleaning operation, participate in replacing a battery, send a status report, perform any communication, send submerged robot content such as a status report, and the like.

The submerged robot may receive the unique signals after the unique signals are converted—as they originated from signals of other properties. The conversion may include changing any feature—for example frequency, amplitude, pattern, and the like. Alternatively—the unique signals are not converted after being generated.

A unique signal may be unique in one or more aspects—for example have a unique frequency spectrum, a unique pattern, a unique intensity and the like. The signals are unique in the sense that they differ (by spectrum and/or by patten and/or by intensity and/or by any other aspect) from other sound signals that the pool related platforms senses—such as sounds generated by the platform it self, sounds generated by a pool fluid management system, and the like. The unique signals may be determined by analyzing signals (during one or more learning periods) generated at an environment of the pool and/or any signals sensed by the submerged robot when underwater—and distinguishing the unique signals from other signals. The unique signals (for example their frequency) may be determined based on an estimate of the sounds generated in the environment—for example speech, splashes of water, sound of a human entering the pool, sound of pool drainage system, and the like. The unique signals may have significant high frequencies in relation to other signals generated by the pool related platform or the environment.

The unique signals may be generated by a person, by a grogger, by a mechanical signal generator, by a speaker, by any other signal generator, by an above the water device, by a partially submerged device, by a fully submerged device, and the like.

The grogger may be waterproof or non-water proof. The grogger may include a housing in which metal mechanical elements may move and impinge against the housing and/or against each other and generate the unique signals.

The housing may be cylindrical, round or have any other shape. The housing can be waterproof or not water proof.

The mechanical elements may be of any shape—for example balls.

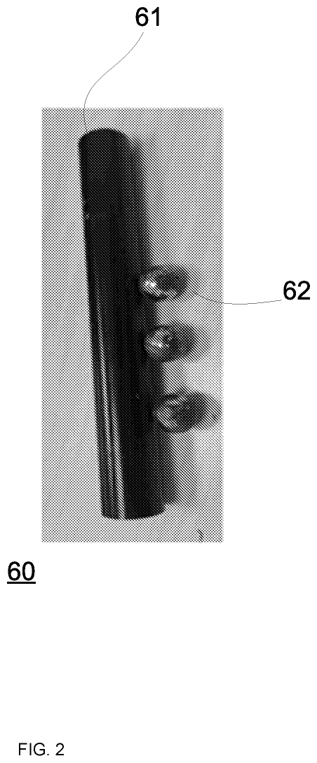

FIG. 2 is an example of a grogger 60. The grogger may include a housing 61 such as a metal cylindrical housing and have metal balls 62 within the housing. The metal cylindrical housing can be coated with a protective oxide layer such as an anodized coating—such as a military grade coating. The coating can be made by a coated aluminum coating. The balls may be hollow or fully filled, may be perforated or not. The grogger may be a hand held grogger.

Non-limiting dimensions of the grogger may be a length of between 5-25 centimeters—especially about 15 centimeters, radius between 10 and 40 millimeters—for example about 21 millimeters. The balls may have a dimension that are smaller than the interior of the cylindrical housing. For example may have a diameter of between 5 and 35 millimeters—for example—about 14 millimeters. The balls may weight between 5 and 50 grams—for example about 12 grams. There may be one or more balls—for example—three balls. Any other weights, number of balls, or any other dimensions or materials may be provided.

The grogger can be moved by a user when out of water, partially submerged or fully submerged. Alternatively—the grogger may be moved by a mechanical unit.

The cylinder housing maybe telescopic, enabling production of more than one type of unique signal.

The pool related platforms may be provided with more than one microphones (or any other acoustic sensors) configured to recognize the location of the signal generator source and to react accordingly. For example when a homing or surfacing command unique signal are send, and the pool related platforms mostly should home or surface near the to the user of the signal generator.

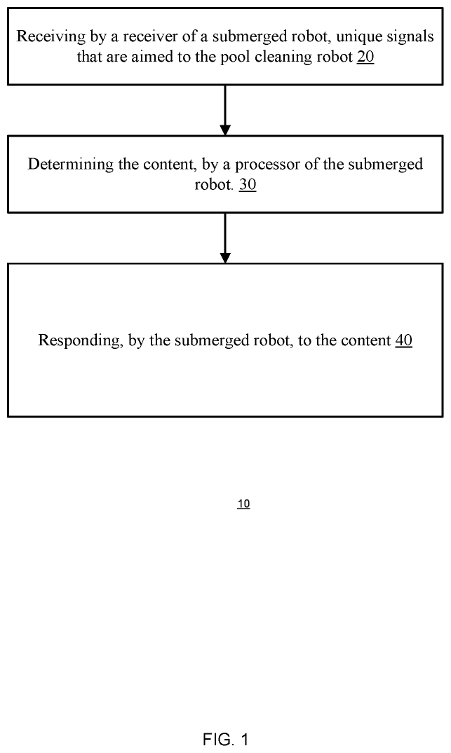

FIG. 1 illustrates method 10 for interacting with a pool related platforms such as a submerged robot.

Method 10 may start by step 20 of receiving by a receiver of a submerged robot, unique signals that convey content aimed to the pool cleaning robot. The receiver may be one or more microphones, one or more ultrasonic sensors and the like. The receive—especially when having two or more sensors—may provide an estimation of the direction from which the unique signals are transmitted.

Step 20 may be followed by step 30 of determining the content, by a processor of the submerged robot.

Step 30 may be followed by step 40 of responding, by the submerged robot, to the content.

### Generating the Unique Signals by an at Least Partially Submerged Device

According to an embodiment of the disclosure, the unique signals may be generated by a partially submerged system. The interacting may include sending sound signals aimed to the submerged robot. The interacting may or may not include receiving content from the submerged robot.

In the following example it is assumed that the sound signals are ultrasonic signals.

The method may include:
a. Receiving (by the partially submerged system) a sound command sound signals aimed to a submerged robot.
b. Converting the sound signals (solely by the partially submerged system) to unique signals such as but not limited to a fluid conveyed signal such as an ultrasonic carried command.
c. Transmitting (by the partially submerged system) the ultrasonic carried command to the submerged robot. The converting and transmitted operations may be merged to a single operation.

For another example, the method may include:
a. Receiving (by the partially submerged system) a sound command aimed to a submerged robot.
b. Converting the sound command to an ultrasonic carried command. Whereas the partially submerged system and a computerized system participate in the converting.
c. Transmitting (by the partially submerged system) the ultrasonic carried command to the submerged robot.

The interacting can be executed solely by the partially submerged system.

Alternatively—the interaction can be done only in part by the partially submerged system.

For example—the interacting may be executed by the partially submerged system and by a computerized system.

The computerized device does not belong to the partially submerged system and does not include the partially submerged system. The computerized device maybe physically separated from the partially submerged.

The computerized system may be a user device, a remote computer, a server, a cloud computer, a mobile phone, a tablet, a laptop, a desktop, and the like.

For example—the participation in the converting may include, for example, at least one out of:
a. Sensing, by a trigger sensing unit of the partially submerged system, a trigger that preceded the voice carried command.
b. Generating after-trigger speech information about speech that immediately followed the trigger.
c. Sending the after-trigger speech information to a computerized system.
d. Sensing speech (with or without speech recognition, for example by sensing a reception of power in a predefined frequency range) by the partially submerged system.
e. Sending the information representing the speech to a computerized system.

The converting may include speech recognition. The speech recognition may be executed by a speech recognition unit that may belong to the partially submerged system, or by a speech recognition unit that may belong to the computerized system.

The speech recognition unit may be implemented in hardware or may be hosted by a hardware processing unit.

The speech recognition unit may be trained to detect predefined commands made by one or more specific user, or may be trained to detect predefined commands made by any person. The speech recognition unit may be trained to detect additional content—but this is not necessarily so.

The speech recognition unit may undergo a general training that is not specific to the user and then can be tuned to commands made by the user.

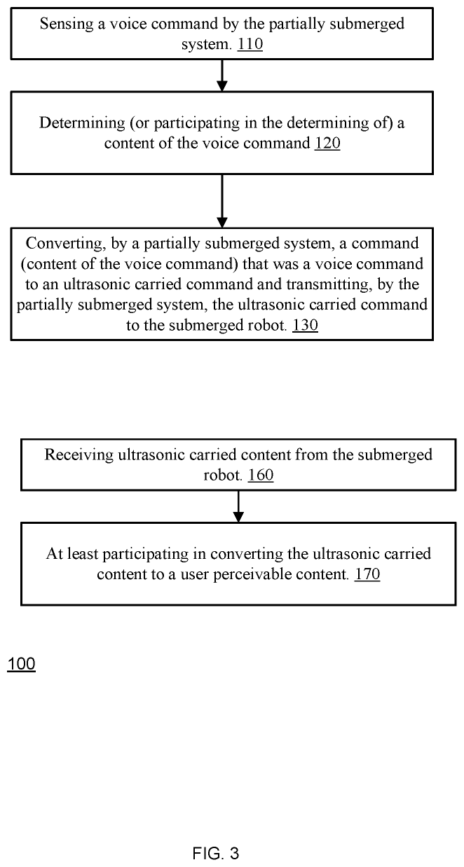

FIG. 3 illustrates an example of a method 100 for interacting with a submerged robot.

Method 100 may start by step 110 of sensing a sound command by the partially submerged system.

It should be noted that step 110 may include sensing voice and checking (by the partially submerged system or by a computerized system) whether the sensed voice includes the speech command. If not—method 110 is terminated.

Step 110 may be followed by step 120 of determining (or participating in the determining of) a content of the sound command.

Step 120 may be followed by step 130 of converting, by a partially submerged system, a command (content of the sound command) that was a sound command to an ultrasonic carried command and transmitting, by the partially submerged system, the ultrasonic carried command to the submerged robot.

Step 120 may include at least one of the following:
a. Performing, by a speech recognition unit of the partially submerged system, a speech recognition process to detect a content of the sound command. The speech recognition may or may not depend on any after-trigger speech information.
b. Sensing, by a trigger sensing unit of the partially submerged system, a trigger that preceded the voice carried command.
c. Generating after-trigger speech information about speech that immediately followed the trigger.
d. Sending the after-trigger speech information to a computerized system.
e. Receiving a content of the sound command, from the computerized system.

Method 100 may include training a speech recognition unit or receiving an already trained speech recognition unit. For example—the speech recognition unit may be trained before being sold to a user, after being received by the user, and the like.

While steps 110, 120 and 130 discusses communication to the submerged robot—method 100 may or may not include receiving communication from the submerged robot.

Accordingly—method 100 may include steps 160 and 170.

Step 160 may include receiving ultrasonic carried content from the submerged robot.

Step 160 may be followed by step 170 of at least participating in converting the ultrasonic carried content to a user perceivable content. The user perceivable content may be an audio content, a visual content or an audio-visual content.

The term “at least participating” may include performing the entire conversion or performing only a part of the converting.

Step 170 may include at least one of the following:
a. Converting the ultrasonic carried content to the user perceivable content by the partially submerged system.
b. Sending the ultrasonic carried content to the computerized system.
c. Receiving information about the content from the computerized system.
d. Extracting a content from the ultrasonic carried command.
e. Wirelessly transmitting information regarding the content to a computerized system.

The ultrasonic carried content may be at least one out of:
a. A response to a command transmitted during step 140.
b. Content that is not related to a command transmitted during step 140.
c. A status report.
d. A request to replace a battery of the submerged robot.
e. A fault report.
f. A confirmation that a command transmitted during step 140 is being executed, was completed, can not be completed, and the like.

The partially submerged system may kept partially floating by using floating elements and/or by being held by an external element—for example by being connected to the sidewall of the pool.

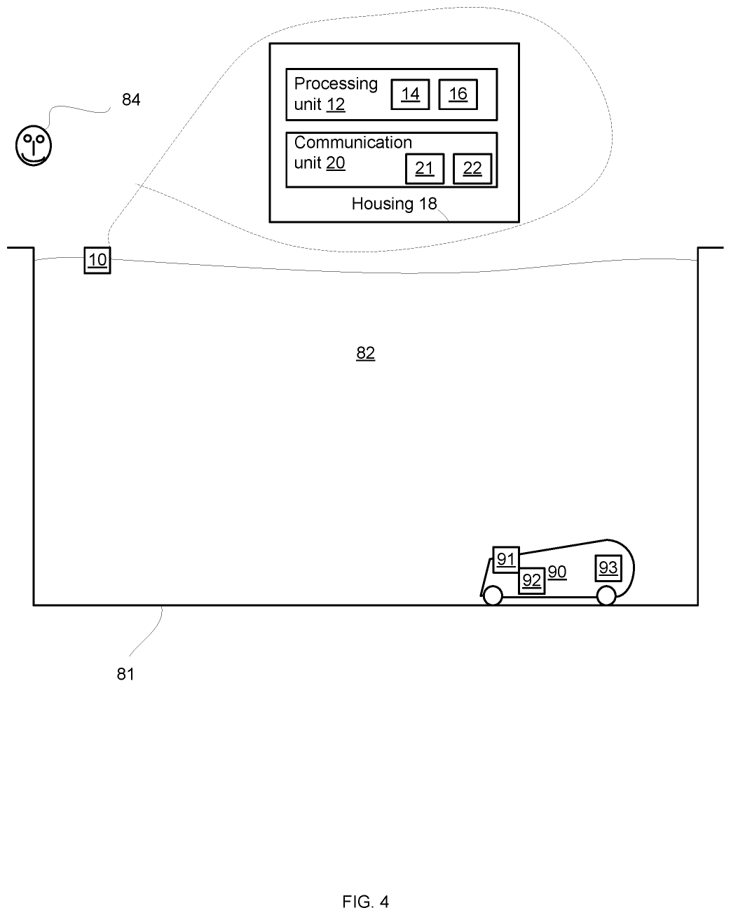

FIG. 4 illustrates an example of a partially submerged system 10 and its environment.

The environment includes a pool 81 that is filled with fluid 82, submerged robot 90 and user 84.

User 84 may wish to communicate with the submerged robot—for example by sending commands, receiving status, and the like.

The submerged robot 90 may include an ultrasonic communication sub-unit 91 (for communicating with the partially submerged system 10), and additional units or components—such as a motor 93, and other components (collectively denoted 92) such as a filter, cleaning elements, and the like. The submerged robot may be a pool cleaning robot, may be a self-moving robot, and the like.

The partially submerged system 10 may include a processing unit 12, a housing 18, and a communication unit 20.

The communication unit 20 may include an audio communication sub-unit 21 and an ultrasonic communication sub-unit 22.

The audio communication sub-unit may include one or more microphones.

The audio communication sub-unit 20 may be configured to receive a sound command that has a content.

The ultrasonic communication sub-unit 22 may be configured to (a) generate an ultrasonic carried command that represents the content of the sound command; and (b) transmit the ultrasonic carried command to the submerged robot.

The ultrasonic communication sub-unit may include one or more ultrasonic transducers.

The processing unit 12 may participate in the conversion of the sound command—especially may be configured to participate in the determining of the content of the sound command.

The processing unit 12 may be configured to perform one out of:
a. Perform a speech recognition process to detect a content of the sound command. The speech recognition may or may not depend on any after-trigger speech information.
b. Sense a trigger (for example a keyword such as “Maytronics”, a name of a robot manufacturer, a reference to the robot such as “hello Robot”), that preceded the voice carried command. The trigger may be used to await a previously idle speech recondition unit.
c. Generate after-trigger speech information about speech that immediately (for example within 10 and 5000 milliseconds) followed the trigger.

FIG. 4 illustrates the processing unit 12 as including the speech recognition unit 14 and the trigger sensing unit 16—but either one of these units may be located outside the processing unit 12.

The communication unit 20 may also be configured to send communications from the submerged robot to the user and/or to a computerized system. For example—the communication unit may participate in steps 160 and/or 170.

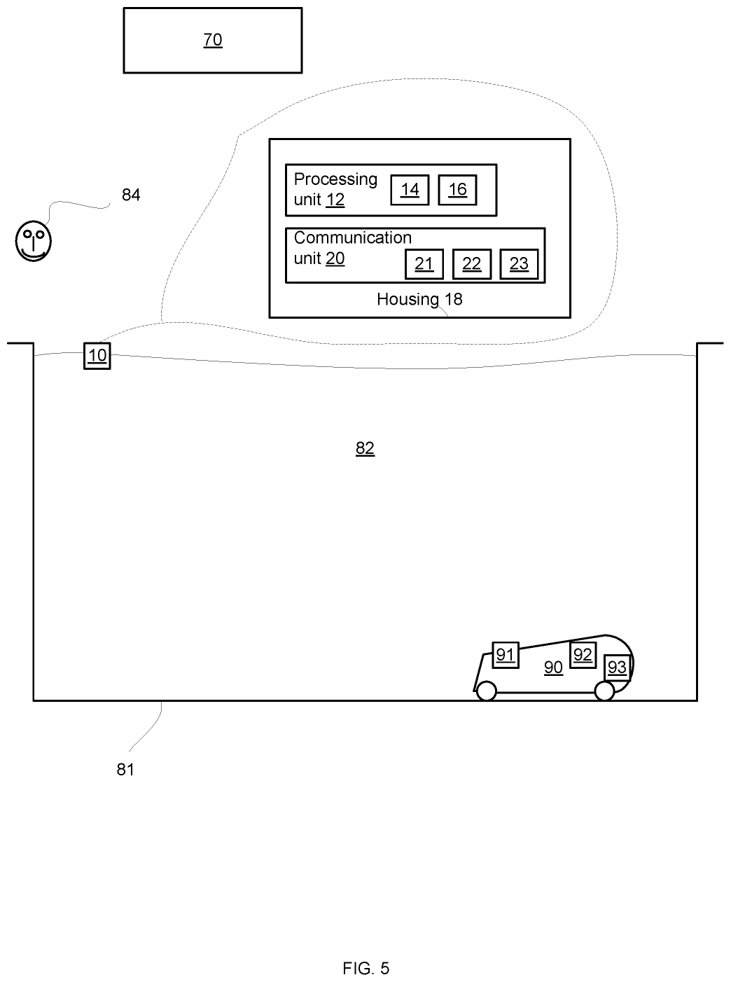

FIG. 5 illustrates the partially submerged system 10 as further including an additional communication unit 23 that is configured to communicate with a computerized system 70. The additional communication unit 23 may not be provided when there is no need to perform out of the water communication with a computerized system.

The processing unit 12 may participate in the conversion of the sound command—especially may be configured to participate in the determining of the content of the sound command.

The processing unit 12 may be configured to perform one out of:
a. Perform a speech recognition process to detect a content of the sound command. The speech recognition may or may not depend on any after-trigger speech information.
b. Sense a trigger that preceded the voice carried command.
c. Generate after-trigger speech information about speech that immediately followed the trigger.
d. Request the additional communication unit to send the after-trigger speech information to a computerized system.
e. Receiving a content of the sound command, from the computerized system

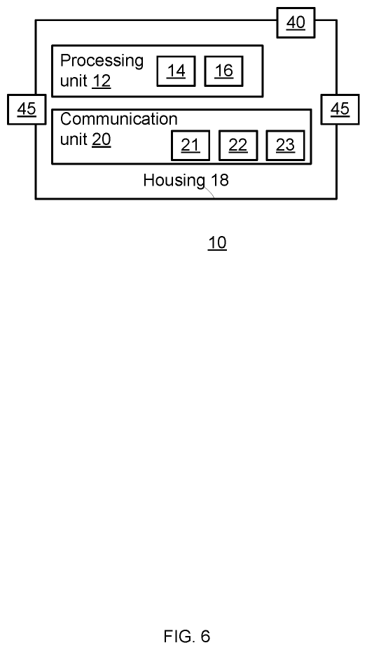

FIG. 6 illustrates the partially submerged system 10 as further including a man machine interface 40 for generating user perceivable content and floating elements 45. The man machine interface may include a waterproof loudspeaker and/or a waterproof light source.

The partially submerged system 10 may be of different shapes and sizes. It may be beneficial to have a small as possible partially submerged system 10—so as not to interfere with users of the pool—but on the other hand the partially submerged system 10 should not be too small—for example to prevent the partially submerged system 10 from being swallowed by users of the pool. Thus—at least one of the height, length and width of the partially submerged system 10 may range between 2 and 20 centimeters—especially between 4 and 10 centimeters.

Any reference to any one of “including” or “comprising” or “having” may be applied mutatis mutandis to any one of “consisting” and “consisting essentially of”. For example—any method may include at least the steps included in the figures and/or in the specification, only the steps included in the figures and/or the specification. The same applies to the pool cleaning robot and the mobile computer.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one as or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements the mere fact that certain measures are recited in mutually different claims does not indicate that a combination of these measures cannot be used to advantage.

Any system, apparatus or device referred to this patent application includes at least one hardware component.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for interacting with a submerged robot, the method comprises:
receiving by a receiver of a submerged robot, unique signals aimed to the submerged robot; wherein the unique signals are sound signals having frequencies that (i are indicative of content conveyed by the unique signals, and (ii) differ from (a) frequencies of sounds generated by the submerged robot, and (b) frequencies of sounds generated by an environment of the pool; and
responding, by the submerged robot, to the unique signals.

2. The method according to claim 1 wherein the unique signals are sound signals having frequencies within a frequency range of 11 Khz to 12 Khz.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. The method according to claim 1 wherein the responding comprises generating and transmitting submerged robot content.

21. The method according to claim 20 wherein the submerged robot content is a status report.

22. (canceled)

23. (canceled)

24. The method according to claim 1 comprising determining the content, by a processor of the submerged robot; and wherein the responding is based on the content.

25. The method according to claim 24 wherein the content is a command.

26. The method according to claim 24 wherein the content is a request.

27. (canceled)

28. The method according to claim 1 wherein the unique signals are generated by a device.

29. The method according to claim 1 wherein the unique signals are human voice signals.

30. (canceled)

31. The method according to claim 1 wherein unique signal are generate by a speaker.

32. The method according to claim 1 wherein the unique signals are ultrasonic signals.

33. The method according to claim 1 wherein the unique signals are generated by a partially submerged system.

34. (canceled)

35. (canceled)

36. The method according to claim 1 wherein the responding comprises surfacing.

37. The method according to claim 1 wherein the responding comprises participating in a replacement of a battery of the submerged robot.

38. The method according to claim 1 wherein the responding comprises moving the submerged robot.

39. The method according to claim 1 wherein the responding comprises generating and transmitting submerged robot content.

40. The method according to claim 39 wherein the submerged robot content is a status report.

41. The method according to claim 1 wherein the responding comprises stopping the submerged robot.

42. The method according to claim 1 wherein the responding comprises reaching a pre-defined location the submerged robot.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. The method according to claim 17 wherein the transmitting submerged robot content comprises transmitting ultrasonic signals from the submerged robot.

79. A submerged robot, comprising:
a receiver that is configured to receive unique signals aimed to the submerged robot; wherein the unique signals are sound signals having frequencies that (i) are indicative of content conveyed by the unique signals, and (ii) differ from (a) frequencies of sounds generated by the submerged robot, and (b) frequencies of sounds generated by an environment of the pool; and
wherein the submerged robot is configured to respond to the unique signals.

80. The submerged robot according to claim 20 wherein the unique signals are sound signals having frequencies within a frequency range of 11 Khz to 12 Khz.
